(19) United States
(12) Patent Application Publication
(10) Pub. No.: US 2026/0137574 A1
(43) Pub. Date: May 21, 2026

(54) SYSTEM AND METHOD FOR HEAD AND NECK STABILIZATION AND IMMOBILIZATION

(71) Applicant: HeadStrait Labs Inc., Pittsburgh, PA (US)

(72) Inventors: Mary SQUIRE, Pittsburgh, PA (US); Alyssa THEROUX, Pittsburgh, PA (US); Zoe White, Pittsburgh, PA (US); James M. Nolan, Pittsburgh, PA (US)

(21) Appl. No.: 19/394,876

(22) Filed: Nov. 20, 2025

Related U.S. Application Data
(60) Provisional application No. 63/722,705, filed on Nov. 20, 2024.

(51) Int. Cl. A61G 13/12

(52) U.S. Cl. CPC A61G 13/121; A61G 13/129

(57) ABSTRACT

This is a medical device consisting of proprietary hardware integrated with sensor technology (telemetry) for head and neck stabilization and monitoring, to offer improved stabilization and comfort while collecting data on the transportation process. By providing critical insights, the efficiency and efficacy of Emergency Medical Services (EMS) and military medical personnel can be enhanced, while also mitigating the risk of neurological worsening.

### CROSS-REFERENCE TO RELATED APPLICATIONS

This application claims the benefit of priority under 35 U.S.C. § 120 of U.S. Provisional Application Ser. No. 63/722,705 filed on Nov. 20, 2024, entitled Head and Neck Immobilization Device and Method of Use Thereof, the content of which is relied upon and incorporated herein by reference in its entirety.

### BACKGROUND

Head and neck injuries can occur when impact or inertial forces on the head are strong enough to deform connective tissues beyond their tolerance limits. High jolts, proximity of the neck to its anatomical joint limits, muscular fatigue and insufficiency, and the properties of head-mounted loads are primary factors that contribute to neck injuries. Current devices, such as cervical collars, aim to stabilize the head and neck but fail to prioritize patient comfort and stability during transportation from the emergency scene to a hospital or trauma center, where the injury can be fully treated.

For cervical immobilization in civilian emergencies, devices like the cervical collar, foam blocks, and long spine boards exist to prevent cervical spine movement. However, these devices do not incorporate smart technology, nor is there a separate device that contributes insights on patient movements. For military medical evacuation, adequate cervical or head immobilization tools are not available. Monitoring technology for military medical evacuation is also limited.

The lack of attention to patient comfort results in patients frequently needing to adjust or shift positions, which can lead to additional movement and discomfort. Currently, there is no solution that accommodates patients of all sizes, causing many individuals to be fitted with improperly sized equipment.

With current stabilization methods and ill-fitting devices, there is no way to ensure correct splint application or detect unwanted movement. This can lead to both discomfort and a higher risk of injury. Additionally, there is no system in place to monitor patient movements and events that could contribute to adverse injuries during extrication and emergency transportation. Current stabilization devices can obstruct the airway and block access to the chest, preventing life-sustaining measures. Because these devices are bulky, they are cumbersome to use and require a lot of much needed space for onboard storage that could be better used in these emergency care situations.

Additionally, patients are not always transported directly from the scene of the injury to the emergency department. There are often multiple handoffs between ambulances, life flights, transfer centers, and hospitals. Each transfer extends the overall transport time and increases the risk of secondary injuries.

There is a need for a stabilization device to advance the safety and outcomes of patients suspected of central nervous system (CNS) injuries, by providing a modern immobilization solution during emergency medical transport and evacuation scenarios.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

This is a medical device consisting of proprietary hardware integrated with sensor technology (telemetry) for head and neck stabilization and monitoring, to offer improved stabilization and comfort while collecting data on the transportation process. By providing critical insights, the efficiency and efficacy of Emergency Medical Services (EMS) and military medical personnel can be enhanced, while also mitigating the risk of neurological worsening.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective view of a head and neck stabilization device in accordance with subject disclosure.

FIG. 2 is a top view of a head and neck stabilization device in a folded configuration in accordance with subject disclosure.

FIG. 3 is a top view of a head and neck stabilization device in a semi-folded configuration in accordance with subject disclosure.

FIG. 4 is another top view of a head and neck stabilization device in a semi-folded configuration in accordance with subject disclosure.

FIG. 5 is a top view of a head and neck stabilization device in a semi-folded configuration with upright folding pieces in accordance with subject disclosure.

FIG. 6 is a perspective view of a head and neck stabilization device in a semi-folded configuration in accordance with subject disclosure.

FIG. 7 is an exploded view of a head and neck stabilization device in a semi-folded configuration in accordance with subject disclosure.

FIG. 8 is a perspective view of a head and neck stabilization device configured on a user in accordance with subject disclosure.

FIG. 9 is another perspective view of a head and neck stabilization device configured on a user in accordance with subject disclosure.

FIG. 10 is a block diagram of a telemetry module for the head and neck stabilization device in accordance with subject disclosure.

FIG. 11 is a block diagram of a process using the telemetry module for the head and neck stabilization device in accordance with subject disclosure.

FIG. 12 is a block diagram of a hardware implementation of the telemetry module for the head and neck stabilization device in accordance with subject disclosure.

### DETAILED DESCRIPTION

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

The following description sets forth illustrative embodiments of integrated systems, devices, and methods that relate to a medical device for head and neck immobilization and protection and method of use thereof. More specifically, the present disclosure relates to a stabilization device with a plurality of attached inertial measurement unit(s) (IMU). The stabilization device with associated sensors can be used to estimate and track head rotation, extension, and all axis motions while restrained, such as in the instance of drops, locking the patient into the ambulance, rapid breaking, ambulance crashes, or during the extrication and transportation of a patient from the site of the accident by way of prehospital services, emergency medical services, emergency medical transportation services, military medical transportation, and other non-emergency medical transportation. It also is capable of patient monitoring in life threatening transportation, such as ambulances and flights, military medicine, hospital trauma units, where head and neck immobilization systems are needed to stabilize and monitor patients with central nervous system (CNS) injuries during emergency transport.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” vent may include multiple vents, and the like.

As used herein, the term “and/or” includes any and all combinations of one or more of the associated listed items. Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Words such as “then,” “next,” etc. are not intended to limit the order of the steps; these words are simply used to guide the reader through the description of the methods.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an embodiment, but any compositions, materials, components, elements, features, integers, operations, and/or process steps that do not materially affect the basic and novel characteristics may be included in the embodiment.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

While specific aspects of the disclosure have been provided hereinabove, the disclosure may, however, be embodied in many different forms and should not be construed as necessarily being limited to only the embodiments disclosed herein. Rather, these embodiments may be provided so that this disclosure is thorough and complete, and fully conveys various concepts of this disclosure to skilled artisans.

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5- fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, may be at least partially performed via at least one entity or actor in any manner.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that may be within the scope of this application.

Unless defined otherwise, all technical and scientific terms used herein have the same meanings as commonly understood by one of ordinary skill in the art.

Numerous specific details are set forth to provide a thorough understanding of one or more embodiments of the described subject matter. It is to be appreciated, however, that such embodiments can be practiced without these specific details.

The present invention relates a smart head and neck immobilization system designed to stabilize and monitor patients with central nervous system (CNS) injuries during emergency transport. It consists of multiple main parts: the splint hardware, the sensing modules, and the software component.

The splint may be designed as a compact, ergonomic device that fits a wide range of patients, from children to elderly and bariatric patients. It cradles the head and neck without pressing on sensitive areas like the occipital bone, ensuring comfort. The device may be quickly applied by one person and is suitable for both military and civilian use. The head and neck stabilization system may be utilized in any of the situations where a user may require a stabilizing device. Such situations may include sporting events, festivals, malls, concert venues, pools, airports, malls, senior living homes, convention centers, apartment complexes, etc. The stabilization system may be stowed, carried, and deployed quickly if any needs arise, thereby providing a lightweight and easy to user alternative to the conventional bulky stretchers or flimsy foam splints. It features straps that secure the head, a quick-release mechanism for easy removal, adjustable sizing, and a design that allows access to critical areas like the airway and trachea. It also fits easily into tight spaces, such as ambulance compartments and military packs.

The present invention provides a system that secures a patient's head without restricting their airways. In contrast to conventional cervical braces, which requires placement around a patient's neck, the present invention provides stability to the patient's head by securing the headplate to the backplate of the brace. Therefore, the backplate may hold the head in place without any constraints around a patient's neck, eliminating any risk of restricting a user's airway. Furthermore, compared to the more intrusive head stabilization systems, such as a halo brace, the present invention may be fastened onto a user's body without requiring anchors or screws under the skin. As a result, the present invention achieves high level of stabilization on the user with minimal trauma on the user's airway and skin.

The sensor technology (telemetry) provides real-time feedback to confirm proper fit. It also has an indicator to ensure the patient remains in a stable position during transport. The sensors monitor head movement, including rotation, flexion, and extension, and track acceleration to detect any bumps or crashes. This data may be used to generate a plurality of metrics, wherein the metrics can be used in real-time to help reduce the risk of further injury and can be analyzed to help improve transport protocols.

The telemetry may comprise a transmission module, such as a transceiver. At least one sensor of the telemetry may be paired with the transceiver, such that any data gathered by the sensors may be transmitted to a local computational device, a mobile device, a clinic server, an emergency provider dispatch center, etc.

In an example, the transmission module may be linked to a plurality of lights installed on the splint. The lights may be configured to activate upon a certain threshold set by a clinician, such that data gathered by the sensors may be checked against it. Should the data indicate movement beyond the certain threshold, the lights may activate and alert the clinician. Thus, the present invention provides real time guidance to the clinicians on safe handling of the patient.

In another example, the transmission module may be linked to a server at a clinic, emergency service center, or any care provider locations. The transmission module may be configured to continuously transmit data gathered by the sensors, such that the patient's head and neck position may be continuously monitored during transit. This provides significant advantages over conventional portable stretchers and splints that do not provide real time feedback to the clinics.

The device logs all this information, which can be used for post-incident analysis and to provide information on the transportation process. Designed as a single-use, disposable device, it meets medical safety standards without needing recharging or sterilization.

The device may comprise of foam or gel and rigid layers. The device can be fully disposable or partially disposable with some reusable parts. The parts will have padding made of some sort of foam or gel to reduce pressure on the patient who is in the device for extended periods of time. The device will secure around the head and trunk to prevent motion in multiple axes.

There are several alternatives that could be used for the material of foam or gel padding on the device that will not alter the structure or design of the device. This also applies for any material that will be used to reduce friction or slippage of the device on the patient's head/hair.

The device may consist of integrated telemetry/sensor technology. The sensor will relay information to the cloud or other local storage and may do so in one of several ways-via Wi-Fi, Bluetooth, LTE, or other modes of data transmission.

The device offers several advantages for patients, users, and buyers alike. For patients, it provides enhanced comfort by reducing pressure points, along with customization through adjustable fit and sizing options. Users benefit from its quick and easy application, while its compact size allows for convenient storage. Additionally, real-time feedback helps users deliver the best possible care while not obstructing other medical interventions, such as intubation or CPR. For buyers, the device helps reduce mishandling and minimizes the risk of secondary injuries, which can result in savings on liability and lawsuit costs. Furthermore, it provides insights to compare and improve performance, and its potential for universal protocols can enhance training and standardization across various applications. Other systems do not include the telemetry/sensor technology related to patient movements during the emergency transportation process.

This disclosure highlights several key features of the device. It is compact and portable, enabling easy transport and use in various settings. Real-time feedback and data logging capabilities allow for continuous monitoring and record-keeping, enhancing patient care and assessment. The device is designed to be safe and comfortable, with an intuitive and user-friendly mechanism that ensures quick and straightforward operation and does not obstruct the airway while other medical interventions are taking place.

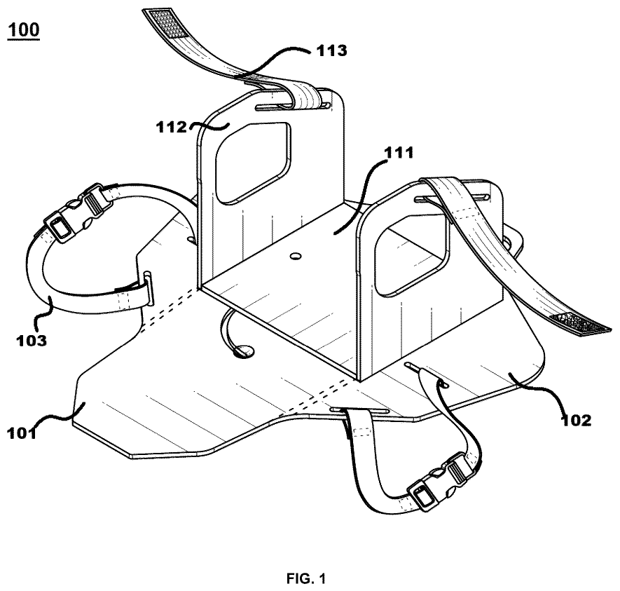

Referring to FIG. 1, a head and neck stabilization device 100 is provided. The device may be configured as a modular head and neck stabilization system designed to stabilize a patient's cervical spine and cranium while accommodating a wide range of anatomical sizes and clinical scenarios. It comprises a headplate 111 operably coupled to a backplate 101, wherein the headplate 111 features a multi-component architecture configured to conform around the user's head, with a pair of folding pieces 112 designed to conform to sides of the user's head. The backplate 101 provides structural support along the thoracic and upper lumbar regions, with a pair of hinged pieces 102 to accommodate user stabilization and storage. The head and neck stabilization device 100 may be engineered to permit controlled vertical adjustment of the headplate 111 relative to the backplate 101 to optimize fit, comfort, and immobilization efficacy.

The backplate 101 may be constructed as a rigid or semi-rigid support element extending longitudinally to support the head, cervical region, and upper torso. It may be contoured to distribute load across the shoulders and upper back while maintaining a generally planar central region for spinal alignment. The backplate 101 may be fabricated from impact-resistant materials to enable diagnostic compatibility and field durability. Peripheral apertures and slots may be provided for straps, accessory attachments, and integration with stretchers or transport systems. The backplate is dimensioned to accommodate users of various ranges and may include padding or removable liners to manage pressure distribution and hygiene. In various examples, the backplate 101 may comprise a tail section that is foldable, thereby able to accommodate wider user sizes and more compact storage capabilities.

The headplate 111 may positioned on top of the backplate 101 and includes a conforming structure 112 configured to stabilize the cranium and lateral aspects of the head. In one embodiment, the headplate 111 comprises a central sliding piece and two folding pieces 112, one at each lateral end. The folding pieces 112 are hinged or otherwise articulable relative to the sliding piece to wrap or fold inward around the user's head, forming a cradle-like configuration. The folding pieces may incorporate padding, contoured surfaces, or compressible elements to improve fit and reduce point loading. The sliding piece provides a stable central contact area beneath the occipital region or at the posterior skull while allowing relative movement with respect to the backplate for fit adjustment. Additionally, the headplate may include a strap 113 configured to span across the user's head and fasten to each folding piece, thereby securing the head against the headplate 111 during transport. Both the backplate 101 and the headplate 111 may be outfitted with soft materials to enhance comfort of the user, wherein the soft materials may be foams, fabrics, gels, or other natural or synthetic cushioning material.

The headplate 111 may be attached to the backplate 101 via a coupling that enables controlled vertical translation of the headplate 111 relative to the backplate 101. This allows the clinician to raise or lower the headplate to align the occipital support and lateral folds with the patient's specific cranial height and cervical neutral position. The vertical movement may be realized through a track-and-slider arrangement, telescoping rails, or a guided slot system with incremental detents. A locking element may be configured to secure the headplate at the selected height to prevent unintended motion during use and transport. The locking element may comprise a friction-based mechanism, geometry based lock, a cam lock, spring-biased pin, ratcheting lever, or screw clamp. The coupling may be configured to accommodate variations in head size, shoulder height, and cervical lordosis while maintaining neutral alignment.

The folding pieces 112 are designed to pivot from an open configuration, facilitating patient placement, to a closed configuration, offering lateral containment and stabilization. The folding motion may be limited by stops to prevent over-compression and to maintain a controlled contact profile along the temporal and parietal regions. The central sliding piece interfaces with the backplate's vertical adjustment mechanism and provides a stable base for the folding pieces. In certain implementations, the sliding piece can translate relative to the backplate independently of the folding pieces, enabling fine-tuning of occipital support without altering lateral compression. Optional markings or scale indicators on the sliding piece and backplate guide repeatable positioning.

The geometry and materials of the headplate 111 may be configured to be semi-flexible or segmented to permit contouring around the user's head. This may be achieved through living hinges, articulated segments, or embedded wireframes within a pliable shell. When closed, the folding pieces 112 cooperate with the sliding piece to form a molded, wrap-around support that stabilizes the head in a neutral orientation. The design may include removable, variable-density padding inserts to tailor contact pressure and accommodate anatomical variations, hair volume, and external devices such as oxygen cannulas.

In various examples, the folding pieces 112 of the headplate may be a part of a sliding mechanism on the headplate. The sliding mechanism may be attached to the headplate 111, such that it may slide laterally to and from the center section of the headplate 111. Therefore, the folding pieces 112 may be set at different widths, accommodating any user head size.

In an example, the device may comprise a mechanism to hold the headplates securely at different angles. The mechanism uses a semi-rigid fishbone or knot-and-ball cable anchored at the base of the headplate. Each side wing incorporates a directional locking slot designed to manage the cable's motion during folding and deployment. The slot includes an entry region, which allows free cable movement, and a locking region, which secures the cable once tension is applied.

When the headplate and side wings are in their flat, open position, the cable is already seated within the slot and contains enough slack to allow full folding motion. As the side wings are rotated upward into position, the cable automatically slides through the slot, transitioning from the entry region to the locking region. This motion takes up the slack and produces a self-tightening effect that stabilizes the angle between the wing and central surface of the headplate.

The geometry of the slot allows unidirectional cable movement, wherein the cable can advance from the entry region into the locking region, but cannot retract unless intentionally repositioned. This ensures that the mechanism remains locked under load. If additional tightening is required, pull tabs at the cable ends allow first responders to manually tension the cable further. To release the mechanism, the cable is guided back into the entry region, disengaging the lock and restoring slack for unfolding or removal.

The backplate 101 and headplate 111 components may be constructed from lightweight, radiolucent polymers, or composites with adequate stiffness to resist bending and torsion under load. Hinges and sliding elements can be formed integrally or via low-profile hardware selected to minimize snag points and facilitate cleaning. Surfaces in contact with skin may be covered with antimicrobial, fluid-resistant cushioning that is removable and replaceable. In an example, the backplate and headplate may comprise integrated soft surfaces, such as foams. In an example, the vertical adjustment hardware may be designed for ease-of-use operation and positive tactile feedback to confirm locking.

The headplate 111 and backplate 101 may comprise a plurality of slits, through which straps 103, 113 may be situated. The straps 103, 113 may be used to help secure a patient's head and torso. In an example, the straps 103 on the backplate 101 may be applied across a user's chest, thereby securing the user against the backplate 101. Similarly, the straps 113 on the headplate 111 may be applied across a user's forehead, thereby securing the user against the headplate 111. Therefore, a user may have his head secured in a position by the combined structure and tension of the stabilization device, thereby immobilizing the patient's head and neck during any potential transit.

There may be a plurality of sensors installed to monitor and measure the patient's orientation and relative positions. In an example, a first sensor is installed on the headplate, and a second sensor is installed on the backplate. The sensors may be configured in housings that may be snapped onto the headplate and backplate of the splint. The housings may be placed around the splint in customizable manner to accommodate specific needs of each use case or application.

The sensors may be configured to detect and quantify relative displacement between the user's head and torso during and after application of the device, including movement occurring during transit. Sensor outputs from the headplate and backplate sensors may be sampled at configurable rates and pre-processed on-device using digital filtering and sensor fusion to derive relative translational and rotational head-torso displacement. The conditioned signals may be timestamped via a real-time clock and transmitted to an onboard microcontroller or system-on-module operably linked to a light-based alert system on the brace, such as high-visibility, low-power LEDs placed along the headplate perimeter and backplate shoulder region. Thresholds for displacement magnitude, rate-of-change, and duration may be configurable, either locally or via a paired application, with multi-level alerting that drives LED behaviors. In an example, the LED may be configured to display steady amber for caution, flashing red for critical, or green for stable conditions. In various examples, the LEDs may be programmed to enable escalation logic, such as latching until clinician acknowledgement.

Processing on the device may include event detection with bouncing, posture baselining after immobilization, and environmental movement using adaptive filtering. Firmware may support over-the-air updates and timer supervision. The telemetry module be configured to include dynamic sampling, LED duty-cycling, and sleep states to extend battery life, with battery status indicated via LED patterns.

In addition, movement data may be transmitted, wired or wirelessly, to a remote server for post-processing and analytics. Communication interfaces may include local pairing, Wi-Fi or LTE, Bluetooth, and wired USB-C for clinical docking. Cloud processing may operate in real time to compute trend metrics, generate clinician dashboards, and trigger notifications to external systems via secure APIs. Data retention policies, time synchronization, and audit logging may be supported to facilitate clinical review and quality assurance while maintaining immobilization and data privacy.

The device may comprise a headplate strap 113 that fastens to the folding pieces 112 to secure the user's head against the headplate and may include interfaces for additional forehead and chin straps or harness systems that integrate with the folding pieces to maintain lateral stability without excessive localized pressure. The backplate 101 may feature universal mounting points for head blocks, radiographic markers, or monitoring accessories. Channels and openings can be provided for drainage and to route medical tubing without compromising immobilization. The backplate 101 may also comprise interfaces for additional straps for torso stabilization and anchoring.

In operation, the clinician may unfold the device to expand the backplate and the headplate. The headplate may be rotated from vertical to horizontal orientation, wherein the headplate may be raised or lowered along the vertical adjustment mechanism to align the occipital support with the base of the skull. The clinician may slide the device under the patient, wherein the clinician positions the patient on the backplate and aligns the cervical spine. The folding pieces are then brought inward until snug contact is achieved around the sides of the head, and any straps (head and/or torso) are secured to maintain immobilization. The locking mechanism is engaged to fix the headplate position. The modular nature of the headplate allows reopening of the folding pieces for access without disturbing the backplate alignment, and readjustment can be performed as needed.

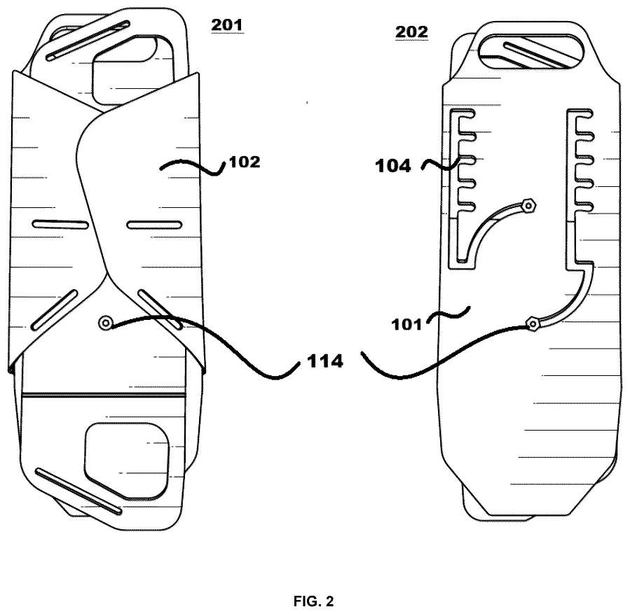

Referring to FIGS. 2-6, a process of unfolding the device in operation. The FIGS. 2-6 may also provide examples of how the device may be assembled and disassembled, as reversing the sequence illustrated in FIGS. 2-6 may instruct how to fold the device back into a storage mode. In FIG. 2, a front and back view of the stabilization device are provided. In the front view 201, it is shown that the folding pieces 102 are folded onto the headplate, which is shown to be in a vertical orientation. In the back view 202, it is shown that the headplate is attached onto the backplate on a pair of rails. The pair of rails may comprise a pair of circular paths leading to a pair of parallel vertical path. As can be appreciated by a person having ordinary skills in the art, the rails may allow the headplate to rotate from a vertical orientation to a horizontal orientation, wherein the headplate may then be moved vertically up to alight with a user's head position.

In the back view 202, it is shown that the a series of rails 104 are provided on the backplate. The rails 104 allow the headplate to be orientated about the backplate according to its path. In an example, the series of rails 104 comprises a pair of parallel rails connected to a pair of circular trails, wherein the pair of parallel rails comprises a plurality of notches. The headplate 111 may comprise a pair of anchors 114 that may be inserted into the rails 104, such that the anchors 114 may move about the rails 104 in order to orient the headplate 111. As can be shown in this example, the anchors 114 may rotate about the circular rails 104, such that the headplate may rotate from a vertical orientation to a horizontal orientation. Subsequently, the anchors 114 may be used to move the headplate 111 along the pair of rails 104 up and down on the series of notches. Furthermore, the headplates may be secured on a position by sliding into the series of notches.

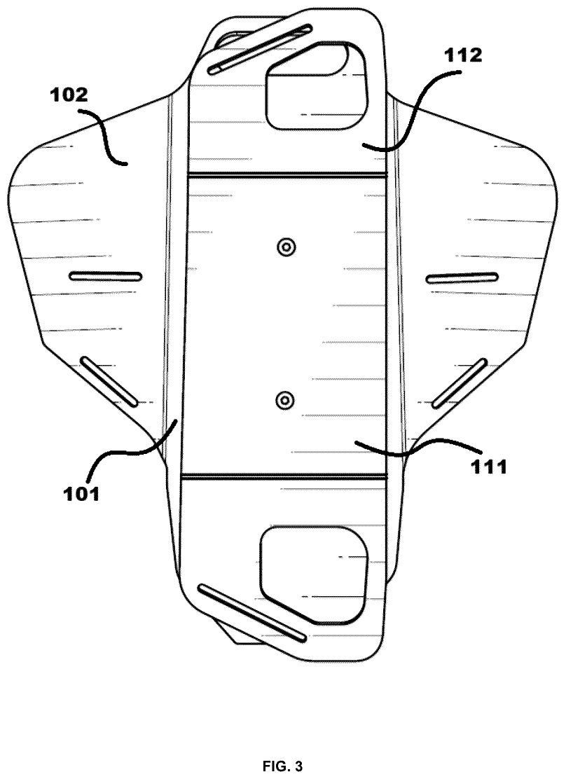

In FIG. 3, a front view of the stabilization device with the folding pieces opened is shown. In this view, the headplate may rest on the backplate in a vertical orientation, and the folding pieces of the backplate may be opened to uncover the headplate thereon. In operation, the clinician may unfold the device to allow access to the headplate in this orientation.

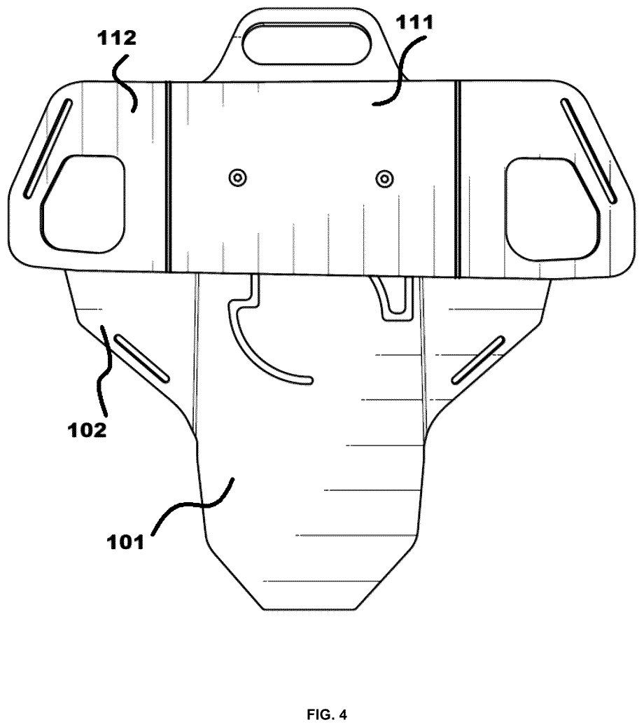

In FIG. 4, a front view of the stabilization device with the headplate in a horizontal orientation is shown. In an example, the headplate may rotate about the rails to transform from its vertical orientation to a horizontal orientation. As can be seen in this example, the headplate may be moved up along the rails to rest in a position that may align with the user's head.

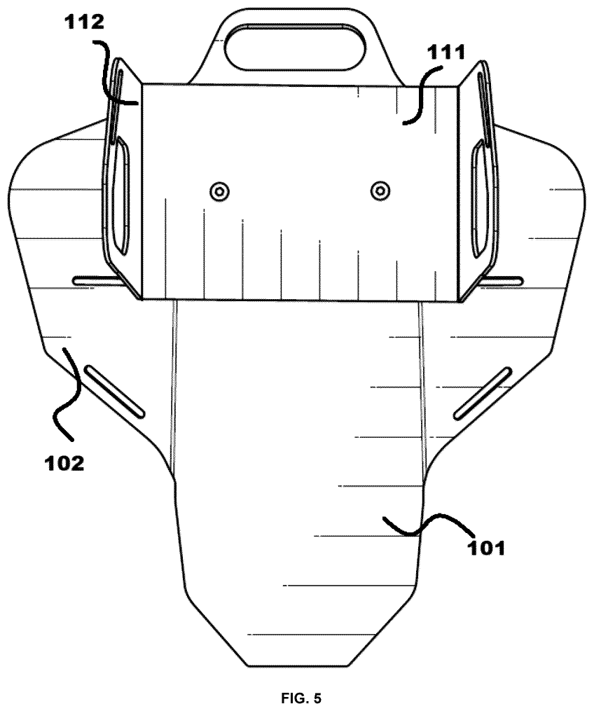

In FIG. 5, a front view of the stabilization device with the headplate folding pieces folded up is shown. In this example, the stabilization device may be in a configuration to receive a patient. As can be seen in FIG. 1, as well, the stabilization device may be outfitted with straps on the backplate and the headplate, wherein the user's head and torso may be further secured against the stabilization device. The distance between the folding pieces on the head plate may be adjusted to accommodate varying sizes of user heads.

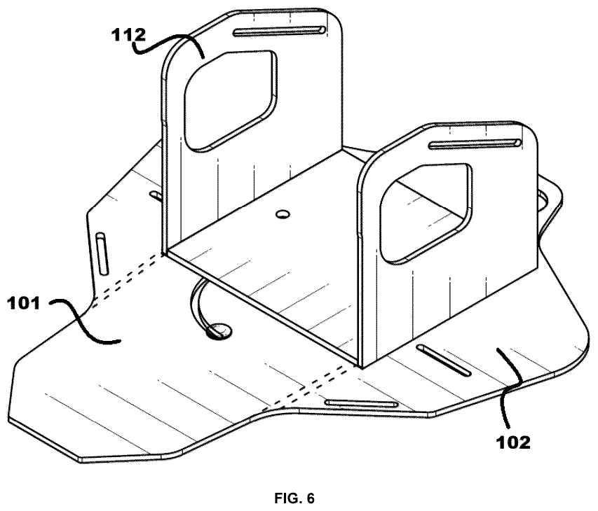

In FIG. 6, a perspective view of the stabilization device in a setup position is shown. In this example, the headplates may be setup such that the folding pieces are ready to secure a user's head by its sides. In this example, the slits on the headplate and the backplate may be used to accommodate a plurality of straps. Furthermore, the backplate may be customized to comprise additional pieces to support the torso, in addition to the straps. In various examples, the design, dimension, and orientation of the backplate and its folding pieces may comprise additional structures to secure a user's torso, beyond the straps as shown in FIG. 1.

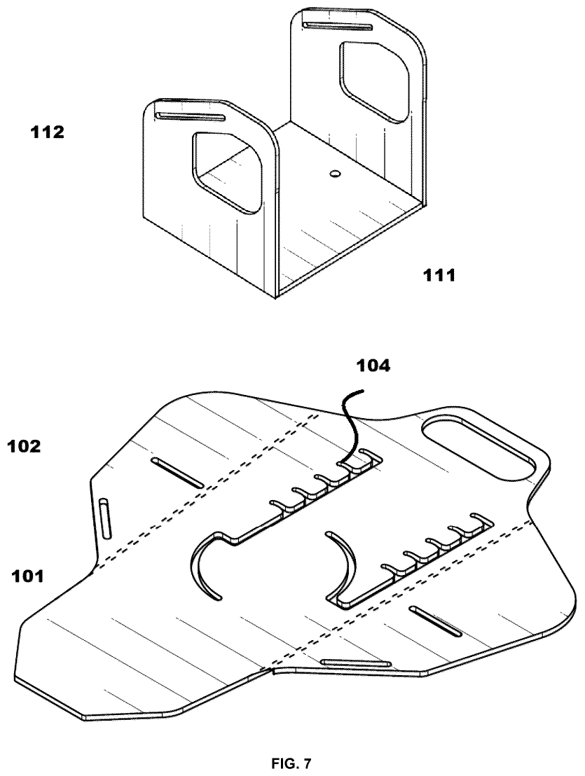

In FIG. 7, a perspective view of a disassembled version of the stabilization device is shown. The headplate may be attached to the backplate by the rail, etched into the backplate. The rails may allow the headplate to be rotated and moved in order to orient about the user's head.

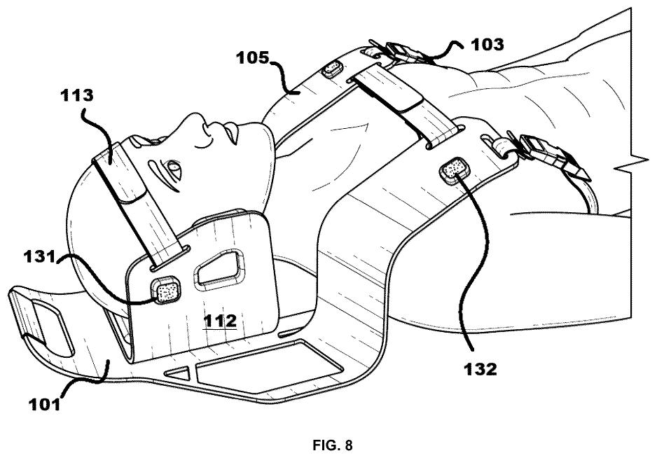

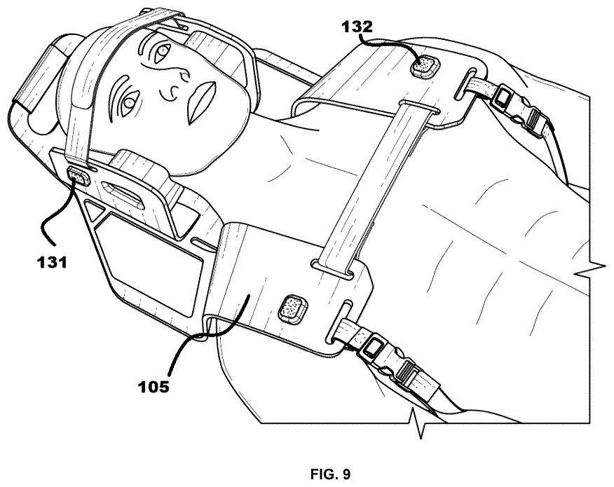

In FIGS. 8-9, an example showing a version of the stabilization device used with a user is shown. In this example, the headplate 111 is oriented such that the folding pieces 112 are adjacent to the sides of the user's head. A strap 113 is fed through the slid on the folding pieces 112 to tie across the user's forehead. As such, the combined orientation of the strap 113 and the folding pieces 112 may ensure the user's head is secured onto the headplate 111.

In this example, the backplate 101 may comprise a pair of risers 105 that may go over a user's chest area. This example may be used for certain application needs, whereas the version shown in other figures may be appropriate in other application needs. In this example, the riser pieces 105 may be folded onto the backplate in a way that is similar to the version shown in FIG. 2, such that the stabilization device may be put into storage mode easily.

In this example, a strap 103 is threaded through a pair of slits on the riser pieces 105 on the back plate 101, wherein an additional pair of straps 103 are attached under the user's armpit. This version of the stabilization device may enable a different manner of securing the user on the backplate.

The stabilization device in this example may be configured with a telemetry module, which comprises a number of sensors 131-132 may be placed on the stabilization device. In an example, a first sensor 131 is installed on the headplate, and a second sensor 132 is installed on the backplate. The sensors 131-132 may be configured in housings that may be snapped onto the headplate 111 and backplate 101 of the splint. The housings may be placed around the headplate 111 and the backplate 101 in customizable manner to accommodate specific needs of each use case or application. The sensors 131-132 may be configured to detect and quantify relative displacement between the user's head and torso during and after application of the device, including movement occurring during transit. Sensor outputs from the headplate and backplate sensors may be sampled at configurable rates and pre-processed on-device using digital filtering and sensor fusion to derive relative translational and rotational head-torso displacement. Processing on the device may include event detection with bouncing, posture baselining after immobilization, and environmental movement using adaptive filtering.

It is clear from this example that stabilization device may secure the user's head without touching the user's neck. This design is advantageous as it does not risk affecting the user's airway. For conventional slings that secure a user's head and neck, usually a neck brace surrounding the neck is provided. Even when the front of the neck brace may comprise a cutout to facilitate easy airflow, convention neck braces nevertheless intrudes on a user's cervical structure. By comparison, the present device uses the orientation of the headplate and the backplate to secure a user's head and neck orientation without touching any part of the user's neck.

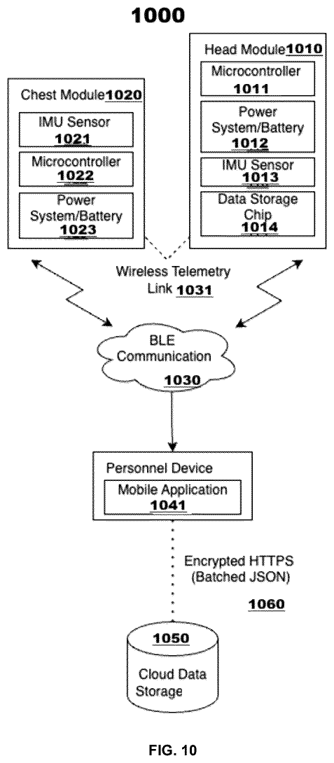

Referring to FIG. 10, a system 1000 for head and neck stabilization may comprise a plurality of telemetry modules, including a head module and a chest module. The telemetry modules may be configured to acquire, combine, and store telemetry data. The head module 1010 may comprise a microcontroller 1011, power system/battery 1012, sensor 1013, and data-storage chip 1014. The chest module 1020 may comprise a sensor 1021, microcontroller 1022, and power system/battery 1023.

Sensors may include a 6- or 9-axis inertial measurement unit (IMU) 1013 in the head module for fine-grained head kinematics and an IMU 1021 or accelerometer in the chest module for torso reference, posture, and gross motion. Additional sensors such as barometric pressure, temperature, or strain gauges may be included as required.

In an example of operation, the chest module 1020 may be configured to transmit packetized telemetry data to the head module 1010 over a wireless telemetry link 1031. The first telemetry module 1010 combines received telemetry with locally acquired telemetry using a clock module and communicates with a personnel device 1040 executing a mobile application 1041 via BLE communication 1030. The mobile application 1041 transfers data to a cloud data storage system 1050 over an encrypted HTTPS link 1060.

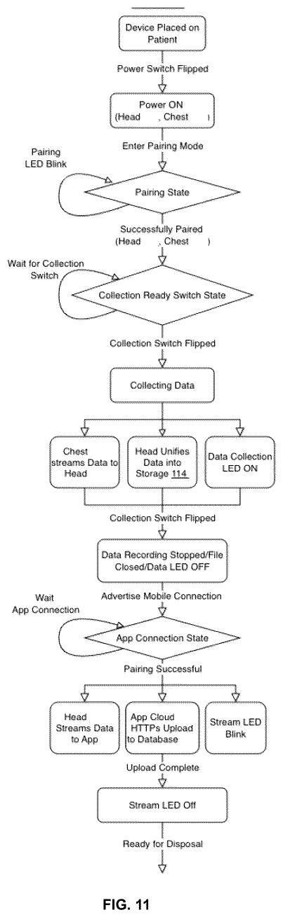

Referring to FIG. 11, a process for pairing, data collection, and upload using the telemetry module of the head and neck stabilization device is illustrated. Both telemetry modules are powered on and enter pairing mode (indicated by blinking indicators). Upon successful pairing, indicators become solid and the system enters a collection-ready state. When a collection control is activated, the chest module may stream telemetry to the head module 1010, which may fuse the incoming telemetry with locally acquired telemetry, timestamps the records, and writes them to storage 1014 while a collection indicator blinks.

When collection is deactivated, recording stops and the first telemetry module 1010 advertises for connection with the personnel device 1040. After the mobile application 1041 connects via BLE 0130, the first telemetry module 1010 streams stored records to the application, which in turn uploads batched data to the cloud data storage 1050 via the encrypted HTTPS link 1060. Upon completion, the transfer indicator signals completion and the system returns to an idle state.

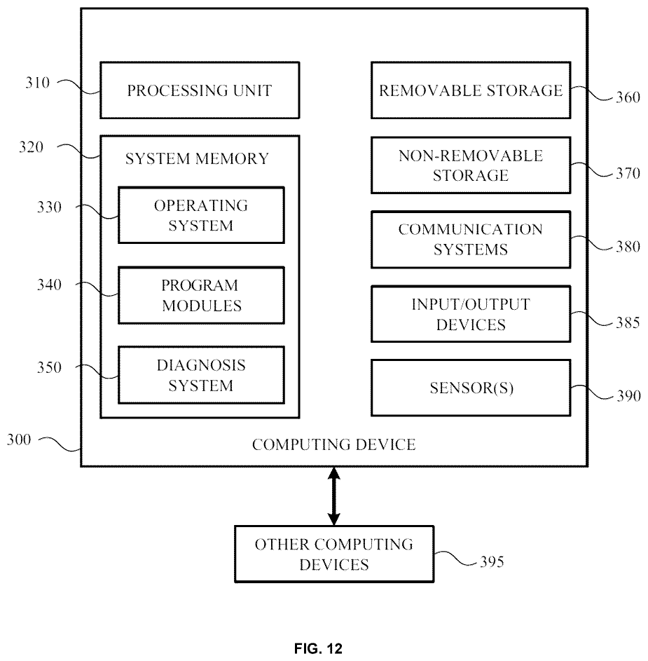

FIG. 12 is a block diagram illustrating physical components (e.g., hardware) of a computing device 400 with which aspects of the disclosure may be practiced. The computing device 400 may be integrated or otherwise associated with any of the various systems described above with respect to FIG. 1. For example, the computing device 400 may be integrated or otherwise associated with a telemetry module for a head and neck stabilization device in FIG. 1.

In a basic configuration, the computing device 300 may include at least one processing unit 310 and a system memory 320. Depending on the configuration and type of computing device, the system memory 320 may comprise, but is not limited to, volatile storage (e.g., random access memory), non-volatile storage (e.g., read-only memory), flash memory, or any combination of such memories. The system memory 320 may include an operating system 330 and one or more program modules 340 or components suitable for performing the various operations described above. The operating system 330 may be suitable for controlling the operation of the computing device 300. The system memory 320 may include a processing unit.

The computing device 300 may have additional features or functionality. For example, the computing device 300 may also include additional data storage devices (removable and/or non-removable) such as, for example, volatile memory, non-volatile memory, magnetic disks, optical disks, or tape. Such additional storage is illustrated in FIG. 12 by a removable storage device 360 and a non-removable storage device 370.

As stated above, a number of program modules 340 and data files may be stored in the system memory 320. While executing on the processing unit 310, the program modules 340 may perform the various processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 400 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general-purpose computer or in any other circuits or systems.

The computing device 300 may also have one or more input/output device(s) 485. These include, but are not limited to, a keyboard, a trackpad, a mouse, a pen, a sound or voice input device, a touch, force and/or swipe input device, a display, speakers, a printer, etc. The aforementioned devices are examples and others may be used. The computing device 300 may include one or more communication systems 480 that allow or otherwise enable the computing device 300 to communicate with remote computing devices 495. Examples of suitable communication connections include, but are not limited to, radio frequency (RF) transmitter, receiver, and/or transceiver circuitry; universal serial bus (USB), parallel, and/or serial ports.

The computing device may include one or more sensors 490. The sensors may include location sensors, accelerometers, position sensors the like.

The term computer-readable media as used herein may include computer storage media. Computer storage media may include volatile and nonvolatile, removable and non-removable media implemented in any method or technology for storage of information, such as computer readable instructions, data structures, or program modules.

The system memory 320, the removable storage device 360, and the non-removable storage device 370 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Supported embodiments include a stabilization device to secure a user's head and neck, comprising a headplate comprising a central piece and two folding pieces disposed at opposite lateral ends of the central sliding piece, the folding pieces configured to transition between an open position and a closed position to conform around a user's head, and a backplate comprises a pair of back folding pieces, a pair of rails, and a series of notches, wherein the headplate attaches to the backplate through the pair of rails and series of notches such that the headplate may slide along the pair of rails to align with the user's head, secure its position on the series of notches, and secure the user's head against the headplate.

Supported embodiments include a stabilization device to secure a user's head and neck, wherein the folding pieces are hinged to the central sliding piece to fold inward around lateral sides of the user's head to form a cradle-like configuration.

Supported embodiments include a stabilization device to secure a user's head and neck, comprising a plurality of straps attached to respective anchors on the folding pieces and back folding pieces.

Supported embodiments include a stabilization device to secure a user's head and neck, wherein the headplate comprises a spring-biased pin or cam lock configured to engage the series of notches.

Supported embodiments include a stabilization device to secure a user's head and neck, wherein the pair of rails comprise linear guides disposed on opposite sides of a superior end region of the backplate to provide symmetrical load distribution during sliding adjustment of the headplate.

Supported embodiments include a stabilization device to secure a user's head and neck, wherein the strap is adjustable in length and includes a quick-release fastener.

Supported embodiments include a stabilization device to secure a user's head and neck, wherein the folding pieces include mechanical stops configured to limit inward rotation and prevent over-compression of the user's head.

Supported embodiments include a stabilization device to secure a user's head and neck, comprising a backplate including a pair of rails, a circular rail connecting the pair of rails, and a series of notches, a headplate attached to the backplate through the pair of rails and the circular rail, the headplate comprising a central sliding piece and two folding pieces positioned on opposite sides of the central sliding piece, and at least one head sensor positioned on the headplate and at least one body sensor on the backplate, wherein the headplate is vertically adjustable relative to the backplate by translation along the pair of rails and rotatable about the circular rail, and a locking mechanism cooperates with the series of notches to fix the headplate at a selected position; and wherein the headplate further comprises a strap configured to fasten to the folding pieces to secure the user's head against the headplate, and the at least one head sensor and the at least one body sensor are configured to measure a displacement data on a user's head and torso.

Supported embodiments include a stabilization device to secure a user's head and neck, wherein the central sliding piece provides an occipital support surface.

Supported embodiments include a stabilization device to secure a user's head and neck, comprises a plurality of padding on the backplate and the headplate.

Supported embodiments include a stabilization device to secure a user's head and neck, comprising a transmission module coupled with the at least one head sensor and the at least one body sensor.

Supported embodiments include a stabilization device to secure a user's head and neck, comprising a telemetry module coupled with the at least one head sensor and the at least one body sensor, wherein the telemetry module comprises a microcontroller.

Supported embodiments include a stabilization device to secure a user's head and neck, wherein the telemetry module is configured to communicate with a mobile device.

Supported embodiments include a stabilization device to secure a user's head and neck, wherein the strap is adjustable in length and includes a quick-release fastener.

Supported embodiments include a stabilization device to secure a user's head and neck, comprising a backplate with a pair of back folding pieces and a headplate operably coupled to the backplate through a pair of rails and a circular rail connecting the pair of rails, wherein the headplate comprises a central sliding piece and two folding pieces positioned on opposite sides of the central sliding piece, and a strap configured to fasten to the folding pieces to secure a user's head against the headplate, and a first sensor installed on the headplate and a second sensor installed on the backplate, the first sensor and the second sensor configured to detect relative displacement between the user's head and torso when the device is in use.

Supported embodiments include a stabilization device to secure a user's head and neck, wherein the first sensor and the second sensor comprise inertial sensors configured to measure translational and rotational displacement of the user's head relative to the user's torso.

Supported embodiments include a stabilization device to secure a user's head and neck, wherein measurements from the first sensor and the second sensor are processed to determine unintended motion of the head relative to the torso to analyze a condition of the user's injury.

Supported embodiments include a stabilization device to secure a user's head and neck, wherein the first sensor is mounted on the folding pieces and the second sensor is mounted on the back folding pieces.

Supported embodiments include a stabilization device to secure a user's head and neck, wherein the first sensor and the second sensor comprise optical, magnetic, or capacitive displacement sensors configured to provide continuous monitoring during patient transport.

Supported embodiments include a stabilization device to secure a user's head and neck, wherein the folding pieces are segmented or formed with living hinges to conform to head contour while maintaining structural support.

It should be understood that the foregoing embodiments can be combined or modified without departing from the spirit and scope of the invention. Features described with respect to one embodiment may be incorporated into others. All components identified as “necessary” in one configuration may be replaced by equivalents that provide substantially the same function.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A stabilization device to secure a user's head and neck, comprising:
a headplate comprising a central piece and two folding pieces disposed at opposite lateral ends of the central sliding piece, the folding pieces configured to transition between an open position and a closed position to conform around a user's head, and
a backplate comprises a pair of back folding pieces, a pair of rails, and a series of notches,
wherein
the headplate attaches to the backplate through the pair of rails and series of notches such that the headplate may slide along the pair of rails to align with the user's head, secure its position on the series of notches, and secure the user's head against the headplate.

2. The stabilization device of claim 1, wherein the folding pieces are hinged to the central sliding piece to fold inward around lateral sides of the user's head to form a cradle-like configuration.

3. The stabilization device of claim 1, comprising a plurality of straps attached to respective anchors on the folding pieces and back folding pieces.

4. The stabilization device of claim 1, wherein the headplate comprises a spring-biased pin or cam lock configured to engage the series of notches.

5. The stabilization device of claim 1, wherein the pair of rails comprise linear guides disposed on opposite sides of a superior end region of the backplate to provide symmetrical load distribution during sliding adjustment of the headplate.

6. The stabilization device of claim 1, wherein the strap is adjustable in length and includes a quick-release fastener.

7. The device of claim 1, wherein the folding pieces include mechanical stops configured to limit inward rotation and prevent over-compression of the user's head.

8. A head and neck stabilization device, comprising:
a backplate including a pair of rails, a circular rail connecting the pair of rails, and a series of notches,
a headplate attached to the backplate through the pair of rails and the circular rail, the headplate comprising a central sliding piece and two folding pieces positioned on opposite sides of the central sliding piece, and
at least one head sensor positioned on the headplate and at least one body sensor on the backplate,
wherein
the headplate is vertically adjustable relative to the backplate by translation along the pair of rails and rotatable about the circular rail, and a locking mechanism cooperates with the series of notches to fix the headplate at a selected position; and wherein the headplate further comprises a strap configured to fasten to the folding pieces to secure the user's head against the headplate, and
the at least one head sensor and the at least one body sensor are configured to measure a displacement data on a user's head and torso.

9. The head and neck stabilization device of claim 8, wherein the central sliding piece provides an occipital support surface.

10. The head and neck stabilization device of claim 8, comprises a plurality of padding on the backplate and the headplate.

11. The head and neck stabilization device of claim 8, comprising a transmission module coupled with the at least one head sensor and the at least one body sensor.

12. The head and neck stabilization device of claim 8, comprising a telemetry module coupled with the at least one head sensor and the at least one body sensor, wherein the telemetry module comprises a microcontroller.

13. The head and neck stabilization device of claim 12, wherein the telemetry module is configured to communicate with a mobile device.

14. The head and neck stabilization device of claim 8, wherein the strap is adjustable in length and includes a quick-release fastener.

15. A head and neck stabilization device comprising:
a backplate with a pair of back folding pieces and a headplate operably coupled to the backplate through a pair of rails and a circular rail connecting the pair of rails, wherein the headplate comprises a central sliding piece and two folding pieces positioned on opposite sides of the central sliding piece, and a strap configured to fasten to the folding pieces to secure a user's head against the headplate, and
a first sensor installed on the headplate and a second sensor installed on the backplate, the first sensor and the second sensor configured to detect relative displacement between the user's head and torso when the device is in use.

16. The device of claim 15, wherein the first sensor and the second sensor comprise inertial sensors configured to measure translational and rotational displacement of the user's head relative to the user's torso.

17. The device of claim 15, wherein measurements from the first sensor and the second sensor are processed to determine unintended motion of the head relative to the torso to analyze a condition of the user's injury.

18. The device of claim 15, wherein the first sensor is mounted on the folding pieces and the second sensor is mounted on the back folding pieces.

19. The device of claim 15, wherein the first sensor and the second sensor comprise optical, magnetic, or capacitive displacement sensors configured to provide continuous monitoring during patient transport.

20. The device of claim 15, wherein the folding pieces are segmented or formed with living hinges to conform to head contour while maintaining structural support.
